(19) United States
(12) Patent Application Publication
(10) Pub. No.: US 2015/0323065 A1
(43) Pub. Date: Nov. 12, 2015

(54) CVT V-BELT OVER-CLAMPING

(71) Applicants: Manousos Pattakos, Nikea Piraeus (GR); Efthimios Pattakos, Nikea Piraeus (GR); Emmanouel Pattakos, Nikea Piraeus (GR)

(72) Inventors: Manousos Pattakos, Nikea Piraeus (GR); Efthimios Pattakos, Nikea Piraeus (GR); Emmanouel Pattakos, Nikea Piraeus (GR)

(21) Appl. No.: 14/690,474

(22) Filed: Apr. 20, 2015

(30) Foreign Application Priority Data
May 12, 2014 (GB) GB1408301.8
Jun. 19, 2014 (GB) GB1410985.4

(51) Int. Cl. F16H 61/662; F16H 55/56; F16H 9/18

(52) U.S. Cl. CPC F16H 61/66272; F16H 9/18; F16H 55/563; F16H 2061/66277

(57) ABSTRACT

Over-clamping compensation mechanisms for the V-belt CVT's, either by using a controllably movable support wherein the spring of the driven pulley abuts, or by using a centrifugal mechanism to offset a part of the action of the spring onto the axially movable half of the driven pulley, applicable in all V-belt CVT's and providing increased efficiency, less power loss, better performance, improved reliability, longer time between overhauls etc.

### BACKGROUND ART

For the control of the transmission ratio, the conventional V-belt CVT (Continuously Variable Transmission) for lightweight vehicles (scooters, motorcycles, ATV's etc) utilizes a variator (which is a kind of centrifugal governor) in the drive (or first) pulley and a spring together with a torque cam in the driven (or second) pulley. The SECVT (Suzuki Electronically-controlled Continuously Variable Transmission) of Suzuki (U.S. Pat. No. 6,405,821), which is regarded as the state-of-the-art CVT for lightweight vehicles, is different: instead of using a variator, it displaces axially, by an electronically controlled mechanism, the sildable half of the drive (or first) pulley and this way it selects the desired transmission ratio; a spring in the driven (or second) pulley together with a torque-cam provide thrust force on the V-belt.

Another kind of V-belt CVT is the PatBox, FIGS. 22 to 24, wherein an auxiliary belt surrounds, and abuts on a part of, the conventional V-belt; a linkage supports the auxiliary belt and provides the necessary force to the auxiliary belt; by displacing the lever, the auxiliary belt varies the effective diameter of one of the two conical pulleys controlling the transmission ratio.

The efficiency (i.e. the ratio of the output power to the input power) of the SECVT has been measured in third-party (Eindhoven University) lab tests (FIGS. 1 and 16) at 95% for medium/low gear ratios (and heavy/medium input torque). At higher gear ratios (overdrive) the efficiency drops well below 90% (especially at medium and light input torque, i.e. at partial loads).

The low gear ratios are used for short periods of time, like during the initial acceleration. Most of the time a V-belt CVT operates at long gear ratios; above a vehicle speed, the V-belt CVT “locks” in the top (i.e. the longest) gear ratio (overdrive).

At medium-high speeds (for instance during a long trip on the highway) the CVT operates, almost permanently, at overdrive and low-medium loads, i.e. at a poor transmission efficiency with increased friction and increased rate of wear of the belt/pulleys. According FIGS. 1 and 16, the friction loss in the SECVT at high gear and 50% load (half open throttle) is more than double as compared to the friction loss at low and medium gear ratios at the same 50% load. In FIG. 16 it is interesting the “agreement” of the over-clamping with the increase of the friction.

FIG. 18 shows a conventional V-belt CVT of the prior art at a low gear ratio (at left) and at a high gear ratio (at right). The power from the engine goes to the first shaft 1 and then to the two halves of the pulley 2 wherein the V-belt 5 abuts. The V-belt abuts also on the two halves of the second pulley 4, with the shaft 3 of the second pulley driving the wheel(s).

A controller (or variator) 6 comprises rollers 7 and sliding surfaces 8 of proper shape.

A spring 9 pushes the axially movable half of the second pulley; it tries to move the two halves of the second pulley close to each other and, so, to shift the belt to a bigger effective diameter.

As the two halves of the first pulley, under the action of the variator/controller, close to each other, the V-belt runs at bigger effective diameters on the first pulley. As a result, the (constant length) V-belt runs deeper in the second pulley (i.e. at a smaller effective diameter) causing the two halves of the second pulley to apart from each other and the spring 9 of the second pulley to get further compressed.

Depending on the load (i.e. on the input torque) the torque-cam causes an increase of the thrust force at low gears.

At high gear ratios the required thrust force and the resulting clamping of the V-belt could be several times smaller, without any risk of belt slipping.

The spring of the second pulley pushes its two conical halves to close; due to the spring action, the V-belt receives thrust forces from the two conical halves that cause radial forces on the V-belt (as in FIG. 3); due to the radial forces the V-belt tries to move to a bigger effective diameter in the second pulley; but the V-belt receives radial forces from the first pulley, too, as the result of the action of the variator that tries to move the two halves of the first pulley close to each other and so to shift the V-belt to a bigger effective diameter in the first pulley. The sum of all the radial force acting on the V-belt must be zero, otherwise the system shifts to another transmission ratio.

Accordingly the total radial force on the V-belt at the one pulley side, needs to be equal with, and opposite to, the total radial force acting on the V-belt at the other pulley side, as in FIG. 18. At the low gear case at left of FIG. 18, a 150 Kp thrust force is applied on the second pulley by the second pulley spring and causes a, say, total radial force of 50 Kp on the V-belt. The first pulley needs to apply an opposite 50 Kp total radial force onto the V-belt, which means that a force of about 150 Kp has to be applied to the axially movable half of the first pulley.

Multiplying the eccentricity R1 of the V-belt at the first pulley by the coefficient of friction (Cf) between the V-belt and the first pulley and by the thrust force (TF, 150 Kp in this case) and by 2 (there are two conical halves wherein the V-belt abuts on, and receives force from) it results the torque capacity Mc of the CVT, i.e.

Mc=R1*Cf*TF*2

The torque M provided by the engine to the CVT input shaft 1 must not exceed the Mc (case without a torque-cam mechanism).

In the high gear ratio case (FIG. 18 at right) the eccentricity R2 has been doubled (the R2 is about twice as big as the R1), which means that the necessary thrust force TF is half (i.e. 75 Kp) in order to maintain the same input torque capacity Mc; however, the spring of the second pulley is now more compressed, resulting in a substantially heavier thrust force (say 210 Kp), which gives a proportionally higher total radial force (70 Kp) on the V-belt, which overloads the V-belt at the first pulley by a proportionally heavier thrust force (about 210 Kp), causing a 280% (2.8=210/75) increase of the torque capacity, i.e. a 180% over-clamping of the V-belt. At light loads this over clamping goes easily well above 500%.

At high gear ratios (overdrive) the thrust force the second pulley applies to the V-belt should reduce substantially (to get only 75 Kp instead of 210 Kp) without any risk of belt slipping.

The extreme and unnecessary over-clamping of the V-belt at specific (and used most of the time) conditions comes from the design/geometry of the conventional variator CVT.

The same extreme and unnecessary over-clamping happens also in the SECVT of Suzuki (as FIGS. 4 and 5 explain: without any risk of V-belt slipping, the necessary clamping of the V-belt is several times lower (depending on the transmission ratio and on the load) than what the SECVT actually uses).

The same extreme and unnecessary over-clamping is also the case in the PatBox CVT.

According the previous analysis, the existing architecture of the V-belt CVT causes a severe over-clamping of the V-belt at the high gear ratios (overdrive), which in turn causes:

additional friction loss,
fast wear of the V-belt,
wear of the pulleys conical surfaces,
substantial increase of the temperature inside the CVT casing and
need for over-ventilation/cooling,
substantial power loss.

### BRIEF DESCRIPTION OF THE DRAWINGS

FIG. 1 shows “the efficiency vs. the gear ratio” of the SECVT at three different loads (input torque).

FIG. 2 shows “the thrust force vs. the gear ratio” of the SECVT at four different loads.

FIG. 3 shows the radial forces caused on the V-belt by the thrust forces the pulleys apply onto the V-belt.

FIG. 4 shows a prior art SECVT at a low gear and at a high gear. It also shows the resulting total radial force on the V-belt. It also shows the principle according which the transmission ratio is controlled in the SECVT.

FIG. 5 shows the application of the present invention in the SECVT of FIG. 4. The spring is not abutting on a surface fixed to the rear axis of the CVT. Instead, the tension (the thrust force) the spring applies to the axially movable half of the second pulley varies controllably (not necessarily according the gear ratio and/or the input torque).

FIG. 6 shows the general arrangement of the SECVT. The three parts at top are the servomotor and the gearing for the control of a screw-shaft that shifts axially the movable half of the drive (first) pulley.

FIG. 7 shows a first embodiment of the present invention on the SECVT. The two systems are quite similar. The difference is in the spring of the second pulley which is now supported by an axially movable thrust roller bearing. A servomotor (the electric motor at the bottom) controlled by an ECU rotates a threaded shaft that cooperates with an immovable threaded member and varies—as required—the thrust force the spring applies to the axially movable half of the second pulley.

FIG. 8 shows magnified the second pulley of FIG. 6.

FIG. 9 shows magnified the second pulley of FIG. 7 and the mechanism that controls the clamping of the V-belt.

FIG. 10 shows the first embodiment at a high gear ratio (overdrive; the eccentricity of the V-belt from the center of the second pulley is small) and with the clamping control mechanism at a position wherein the thrust force on the V-belt is weak.

FIG. 11 shows what FIG. 10, with the difference that the clamping control mechanism is now at a position wherein the thrust force on the V-belt is strong.

FIG. 12 shows the first embodiment at a low gear ratio (the V-belt is at a big eccentricity from the center of the second pulley) and with the clamping control mechanism at a position wherein the thrust force on the V-belt is weak.

FIG. 13 shows what FIG. 12, with the difference that the clamping control mechanism is now at a position wherein the thrust force on the V-belt is strong.

FIG. 14 shows the prior art SECVT.

FIG. 15 shows another arrangement in comparison to the prior art. The spring of the second pulley is not rotating with the second pulley.

FIG. 16 shows “the efficiency vs. the gear ratio” of the state-of-the-art SECVT at three different loads (input torque), it also shows the over-clamping of the V-belt.

FIG. 17 shows the “engine rpm vs. vehicle speed” plot (continuous line) of a typical variator CVT. From p1 to p2 the automatic clutch engages. From p2 to p3 the centrifugal forces on the rollers of the variator are not adequate to increase the effective diameter of the first pulley and to compress the spring of the second pulley. From p3 to p4 the gear ratio increases progressively without a substantial increase of the engine r.p.m. (the vehicle speed increases with the engine operating at about the same r.p.m.). At p4 the CVT is at its top gear ratio (overdrive). From p4 to p5 the increase of the vehicle speed is directly proportional to the increase of the engine r.p.m.

The same plot shows, by dashed line, the clamping of the V-belt (without the torque cam). In the conventional V-belt CVT the clamping is the s1 to s2 to s3 to s4 line: as the gear ratio increases, the clamping of the V-belt increases substantially. In the modified, according the present invention, variator CVT, the clamping of the V-belt drops substantially at higher gear ratios (c1 to c2 to c3 line).

FIG. 18 shows a conventional V-belt variator CVT. A variator 6 on the first pulley 2 controls the gear ratio by increasing, against the action of the spring 9 of the second pulley 4, the effective diameter of the first pulley.

FIG. 19 shows a second embodiment wherein the conventional V-belt variator CVT of FIG. 18 is modified according the present invention. In the second pulley it has been added a centrifugal mechanism 10 that reduces progressively, as the angular speed of the second pulley increase (i.e. as the vehicle speed increases), the total axial force (thrust force) acting from the second pulley to the V-belt.

FIG. 20 shows what FIG. 19 from a different view point; at right they are shown the two basic parts comprising the second pulley and the over-clamping compensation mechanism.

FIG. 21 shows what FIG. 19, with the section areas hatched. Dense cross-hatching fills the section of the V-belt.

FIG. 22 shows a bicycle wherein the conventional “set of front sprockets/chain/set of rear sprockets/gearshift mechanism” is replaced by a Pat-Box CVT comprising: a front conical pulley, a V-belt, a rear conical pulley, an auxiliary belt and a control lever.

Each conical pulley has its own spring. The rider by displacing the lever varies, through the auxiliary belt that abuts onto a part of the V-belt, the effective diameters of the two conical pulleys, and so the transmission ratio. In FIG. 22 the transmission ratio is short. At the bottom it is shown, from two different viewpoints, the transmission system alone.

FIG. 23 shows the what FIG. 22 at a long transmission ratio

FIG. 24 shows a third embodiment. In the second conical pulley of the CVT of FIGS. 22 and 23 it has been added a centrifugal over-clamping compensation mechanism.

FIG. 25 shows a spring having weights properly linked on it. By replacing the conventional spring of any of the CVT's of FIGS. 4, 18 and 22 by the spring of FIG. 25, the over-clamping of the V-belt can significantly drop at the higher angular speeds of the second pulley. This is the fourth embodiment.

FIG. 26 shows another version of the fourth embodiment. The spring is in an articulated spring-casing having weights at an eccentricity. At higher angular speeds the weights reduce the force the spring applies to the second pulley.

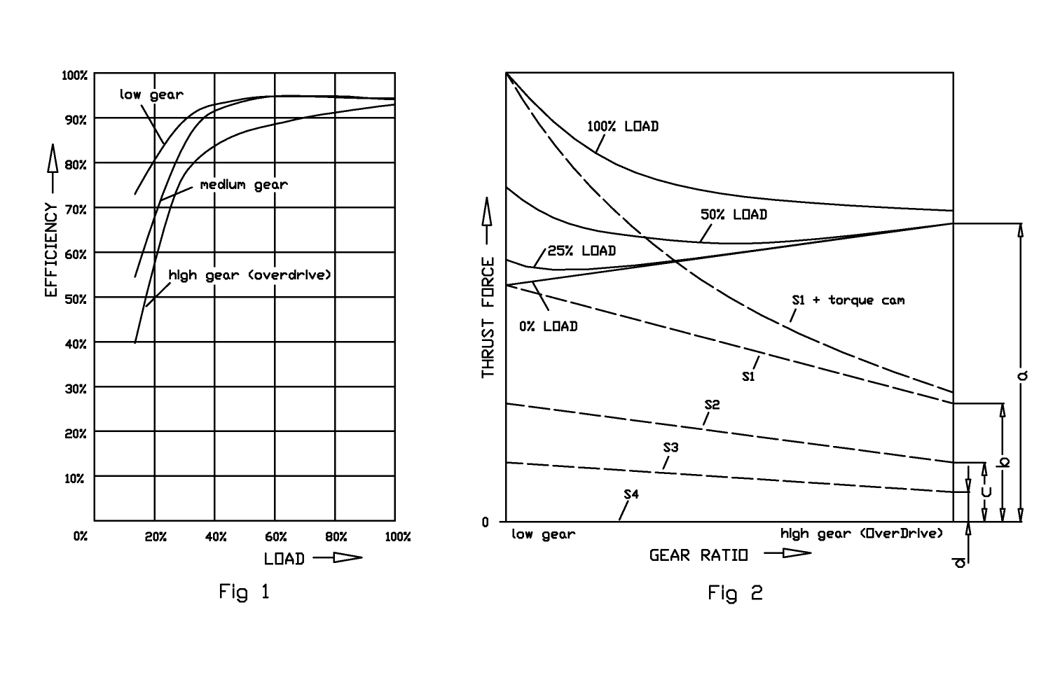

### SUMMARY OF THE INVENTION

In the SECVT an electric motor, under the control of an ECU (electronic control unit), displaces a threaded shaft, which is in cooperation with a stationary threaded member. The threaded shaft holds, by a roller bearing, the slidable half of the first pulley. As the two halves of the first pulley close progressively to each other, the V-belt runs at bigger effective diameters on the first pulley. As a result, the (constant length) V-belt runs deeper at the second pulley (i.e. at a smaller effective diameter) causing the two halves of the second pulley to apart from each other and the spring of the second pulley to get further compressed, as shows the line “0% LOAD” in FIG. 2. Depending on the load (i.e. on the input torque) the torque-cam causes a substantial increase of the thrust force at low gears.

However at high gear ratios the required thrust force could reduce several times, without any risk of belt slipping.

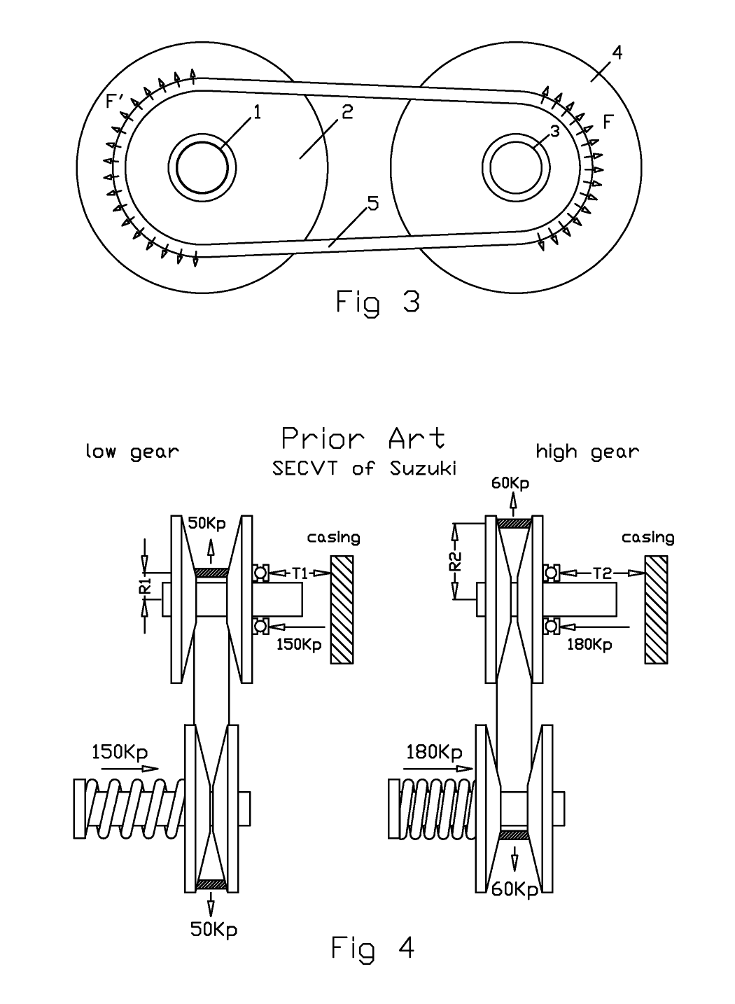

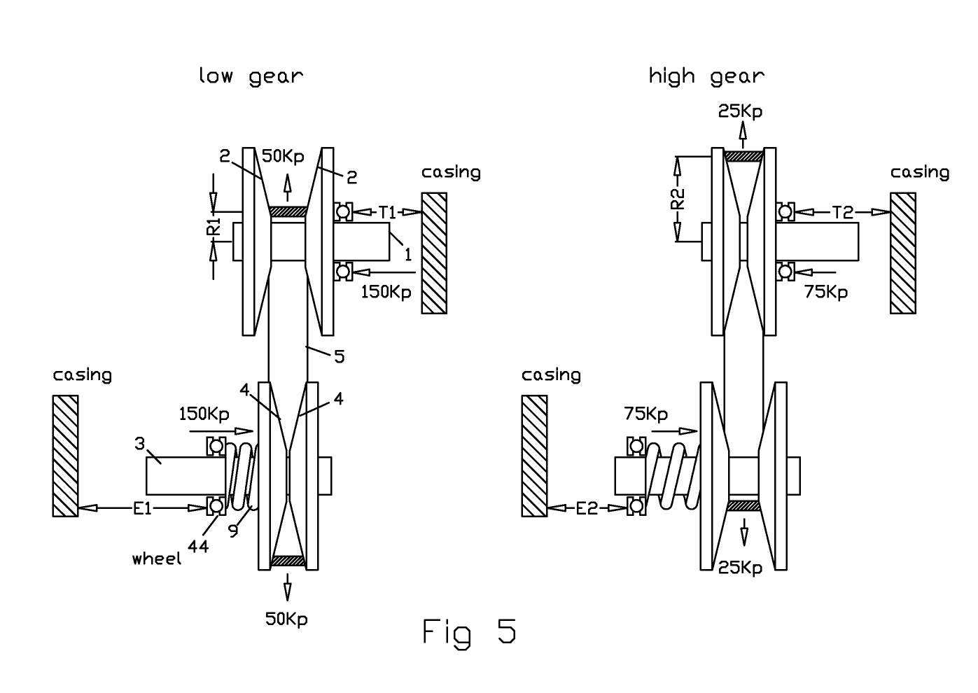

In FIG. 3 they are shown the radial forces caused on the V-belt as it is squeezed between the halves of the two conical pulleys. In order to remain in its position, the radial forces F applied on the V-belt by the one pulley need to counterbalance the radial forces F′ applied on the V-belt by the other pulley. The radial forces F, F′ are proportional to the thrust forces applied by the pulleys to the V-belt.

The dashed lines S1, S2, S3 and S4 of FIG. 2 correspond to 100%, 50%, 25% and 0% load respectively; but in this case with the appropriate control over the thrust force that squeezes the V-belt, the over clamping is substantially reduced without risk for belt slipping.

The dashed lines S1, S2, S3 and S4 are “theoretical” and give the “necessary” thrust force for 100%, 50%, 25% and 0% load respectively; necessary in the sense that with such a thrust force there is no belt slipping; in the following it is explained how these lines result. The “S1+torque cam” curve is for 100% load with the assistance of the torque cam.

The left end of the “100% LOAD” “lab measured” curve coincides with the left end of the “S1+torque cam” curve.

By removing the “torque cam”, it results the left end of the S1 line. The right end of the S1 line is 50% lower than its left end because at the top gear (overdrive) at right, the eccentricity of the V-belt in the front pulley is double as compared to the eccentricity of the V-belt in the front pulley at the lowest gear, at left.

In order to pass only 50% of the load, the required thrust force is half as compared to the 100% load case. This is the way the S2 line results from the S1 line. And so on for the S3 and S4 lines. For a specific load (input torque) and gear ratio, the difference between the “lab measured” curve and the “theoretical” one, gives the “over clamping”, i.e. the surplus of thrust force that unnecessarily loads the V-belt, the pulleys, the bearings, etc. For instance, and according FIG. 2, at half load and overdrive the over-clamping is: (a−c)/c, which is 400%. That is, at top gear (overdrive) and half load, the actual clamping of the V-belt of the SECVT of Suzuki is five times heavier than what it is really necessary.

At full load and top gear the over-clamping drops to “only” 150%. At 25% load and top gear the over-clamping rises to 900%.

In a realization of the present invention, an over-clamping compensation mechanism displaces axially the support of the one end of the spring of the driven pulley, and decompresses/compresses the spring in a predetermined way (for instance, if the axial displacement of the support of the spring increases linearly with the vehicle speed and also decreases linearly with the throttle opening (load), the action of the compensation over-clamping mechanism increases at higher speeds and light loads).

In a more advanced realization, the CVT comprises a pair of sensors providing the instant angular velocities of the two pulleys.

In case the ECU detects a condition wherein, for the existing displacement of the movable half of the first pulley, the relation of the two angular velocities is out of the expected limits (i.e. in case “slipping” starts), the electric motor, under the control of the ECU, compresses a little further the spring to cancel the belt slipping. This way, the CVT can, at all conditions of vehicle speed and load, operate with near zero over-clamping, maximizing the efficiency and minimizing the wear of the V-belt.

In an auto-diagnose mode (used from time to time) the ECU can intentionally increase (or maximize) the thrust force (in order to minimize the belt slipping) and store in a memory the angular velocities of the two pulleys and the axial displacement of the movable half of the first pulley. The array can later be used to detect the beginning of belt slipping and to cancel it.

The control over the compression of the spring makes a torque-cam mechanism optional. For instance, the moment the ECU detects an increase (or an intension for increase) of the load (like: wider open throttle), it commands the electric motor to further compress the spring; after the transient conditions, the ECU can progressively release the spring as required in order to reduce the V-belt over-clamping.

Reducing or eliminating the over-clamping, the same V-belt and pulleys are capable to transmit a substantially larger amount of power (and torque) without reliability issues or overheating, making the same CVT appropriate for other more demanding applications. The control over the active length of the spring is applicable not only in the SECVT but also in the conventional variator CVT, etc. The substantial reduction of the over-clamping can be realized not only by controlling the active length of the spring of the driven pulley, by also with mechanisms counterbalancing a part of the action of the spring onto the driven pulley (like, for instance, a variator properly arranged on the driven shaft/pulley).

### PREFERRED EMBODIMENTS

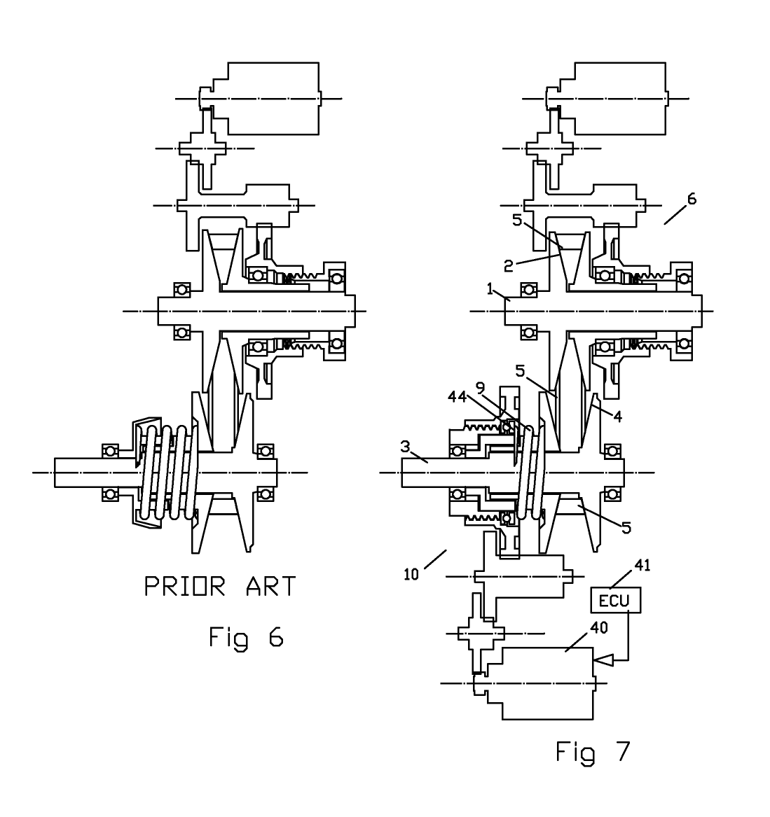

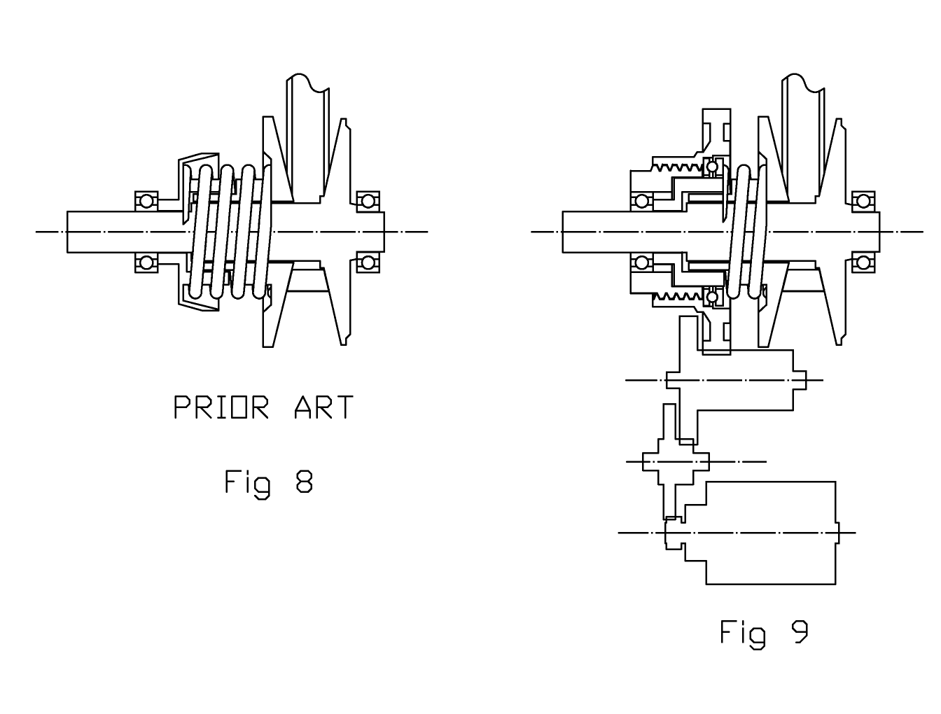

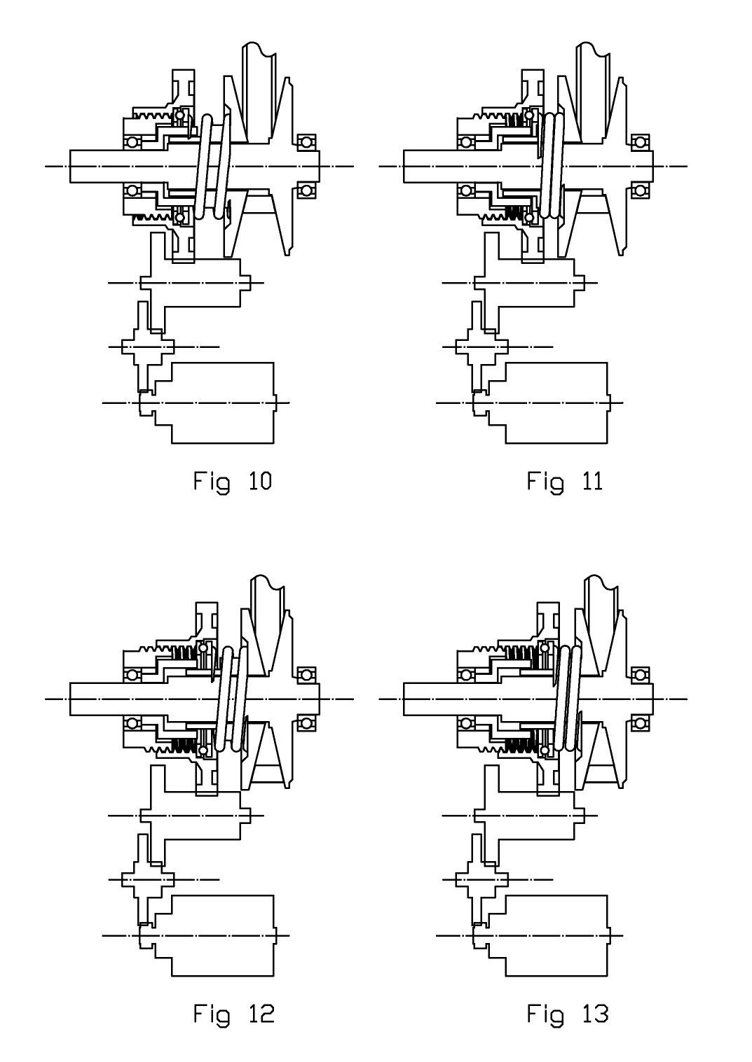

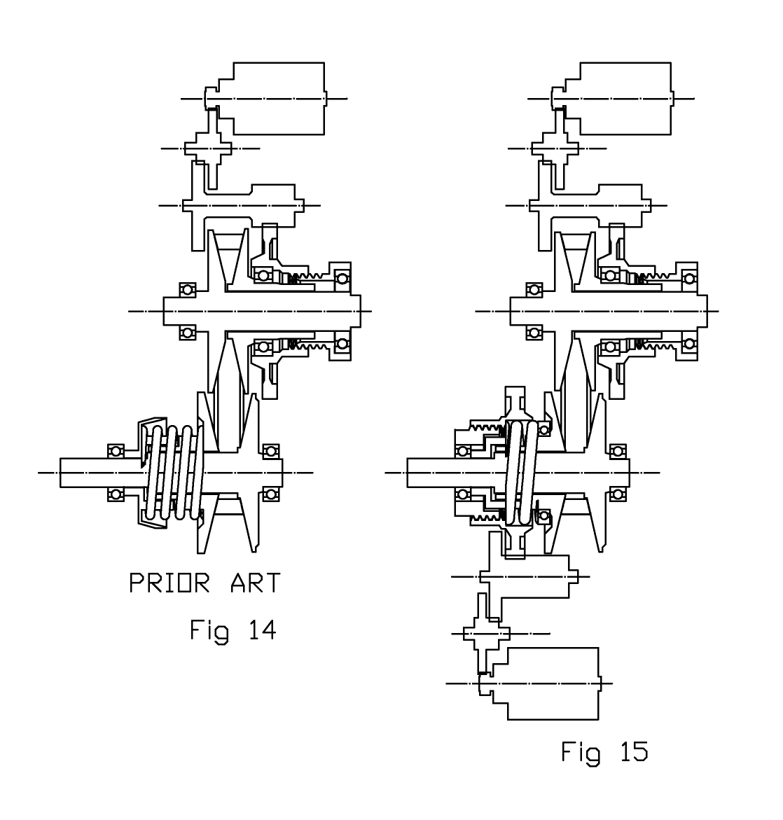

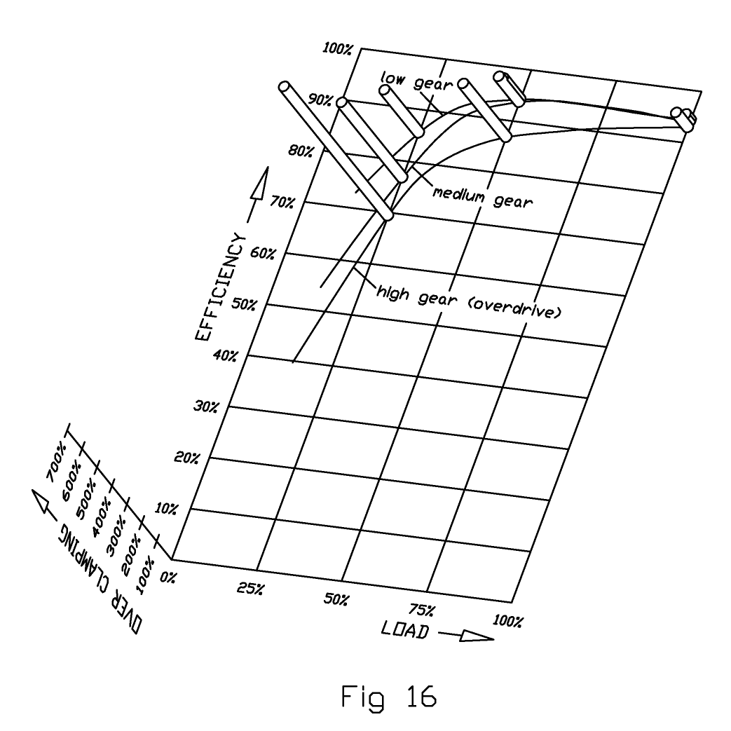

A first embodiment is shown in FIGS. 5 to 15.

If, as shown in FIG. 5, the distance E from the casing of the one end of the spring of the second pulley is properly controlled/varied, the thrust force applied on the V-belt is controlled. This way the clamping of the V-belt can remain in the safe side (to avoid belt/pulley slipping) without “over clamping”. For instance, with the proposed system the spring at low gear can be substantially more compressed (as shown at left) than at high gear (at right). This way, the efficiency at high gears (overdrive), i.e. wherein the CVT is used most of the time, has no reason for not being better than the efficiency at low gear.

From FIG. 5 it is obvious that in order to control the axial displacement E of the surface wherein the spring abuts and is supported (i.e. in order to control the thrust force on the V-belt) it can be utilized, among others, a mechanism similar to the mechanism used for the control of the transmission ratio of the SECVT (which actually controls/varies the axial displacement T of the roller bearing that holds/supports the slidable half of the drive pulley).

By a secondary mechanism similar to the mechanism used for the axial shifting of the slidable half of the first pulley of the SECVT, the force the spring of the second pulley applies to the movable half of the second pulley can be varied/controlled.

For instance, in a screw-shaft (comprising a gear wheel for its rotation by the servomotor under the commands of the control unit) a thrust roller bearing is mounted; the rotating side of the thrust roller supports the free end of the spring of the second pulley and rotates with it. The screw-shaft cooperates with an immovable “nut” secured on the casing. Depending on the angular displacement of the screw-shaft, the thrust roller bearing is axially displaced and the force the spring applies to the movable half of the second pulley varies widely and controllably.

The same electric motor (servomotor) can actuate both mechanisms. The loads on the electric motor decrease, because now the electric motor needs not to compress an overstressed spring (as explained, at high gears the necessary thrust force onto the V-belt drops substantially without a risk for belt slipping). Alternatively, a different servomotor can be used. In such a case the thrust force (the clamping) of the V-belt can be controlled independently from the transmission ratio: for instance the thrust force can be reduced progressively until the system to “detect” the beginning of slipping between the V-belt and the pulleys. This way the system can minimize the over clamping (and consequently the friction, the temperature, the wear of the V-belt and the power loss). It can also be avoided (or be limited) the use of a torque-cam mechanism (the thrust force is increased by making use of the torque-cam; at a certain load the cam will press against the follower, causing an additional thrust force on the belt).

In the arrangement shown in FIG. 15 the thrust roller bearing is disposed between the spring and the slidabe half of the driven (or second) pulley; this way the spring does not follow the rotation of the second pulley, ridding the CVT from vibrations, from increased rotating mass etc.

By the strict control over the thrust force that acts on the V-belt (clamping control), the efficiency of the CVT is improved at all ratios and loads, with the greatest improvement being at the long ratios (i.e. at higher angular speeds of the driven shaft) and at the light loads (i.e. wherein a typical CVT operates most of the time). As the strict control over the transmission ratio of the SECVT is so important in order to keep the engine at the “best point” (whatever this means, like “best” for economy, best for “performance” etc), similarly important is the strict control over the clamping of the V-belt in order to minimize the friction and the wear. With the minimum safe clamping, a CVT is capable for transmitting substantially more power at a higher efficiency.

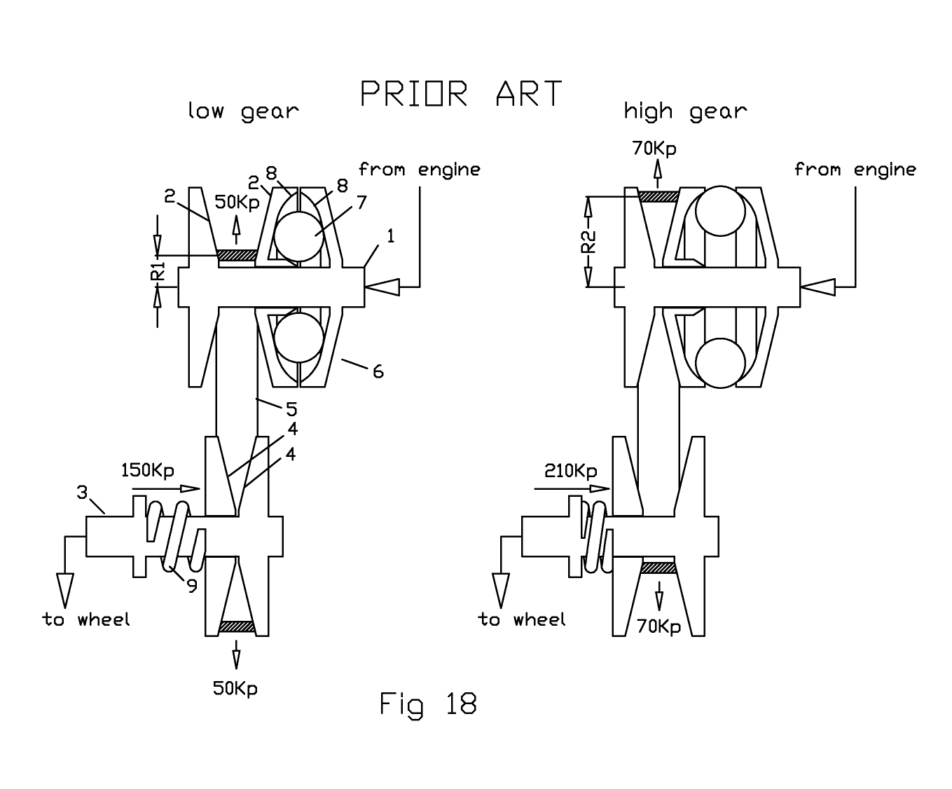

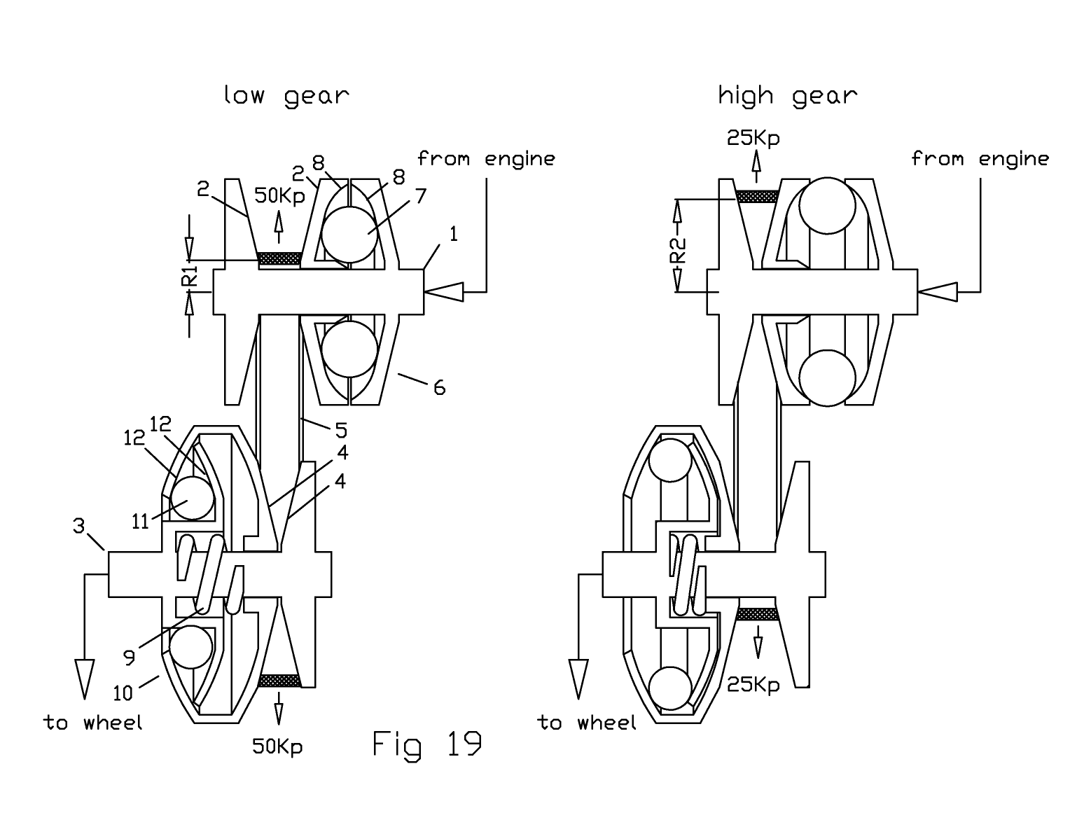

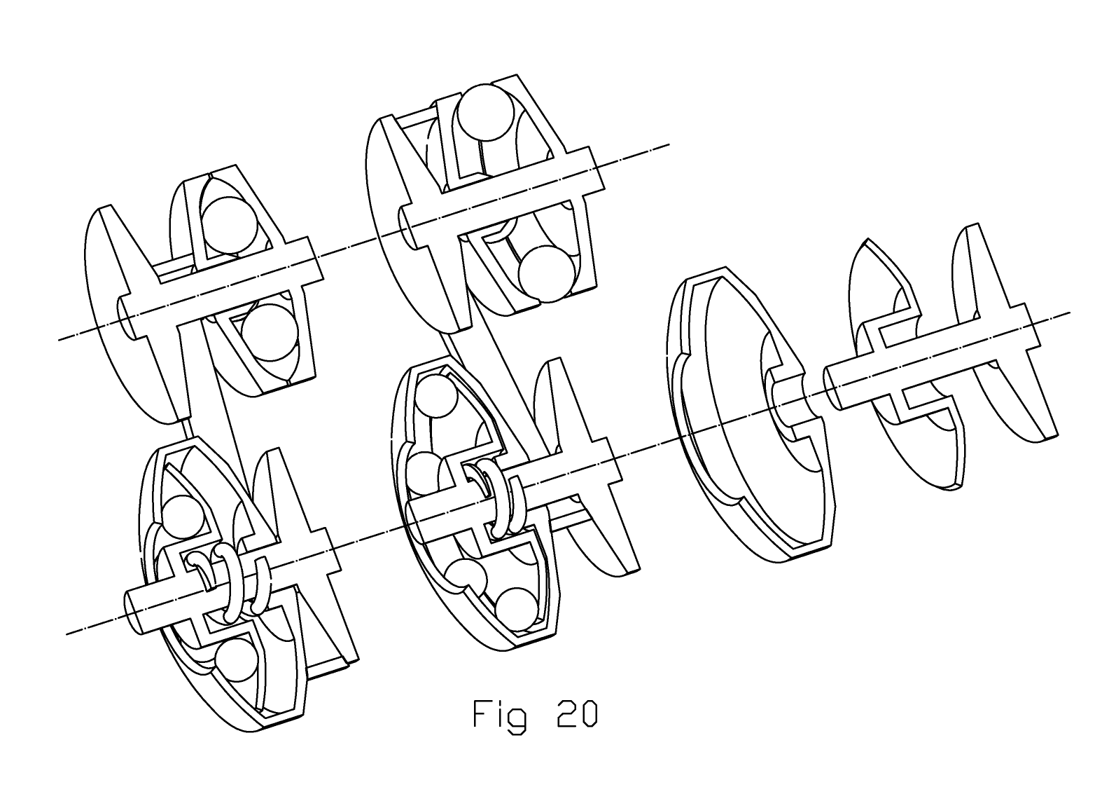

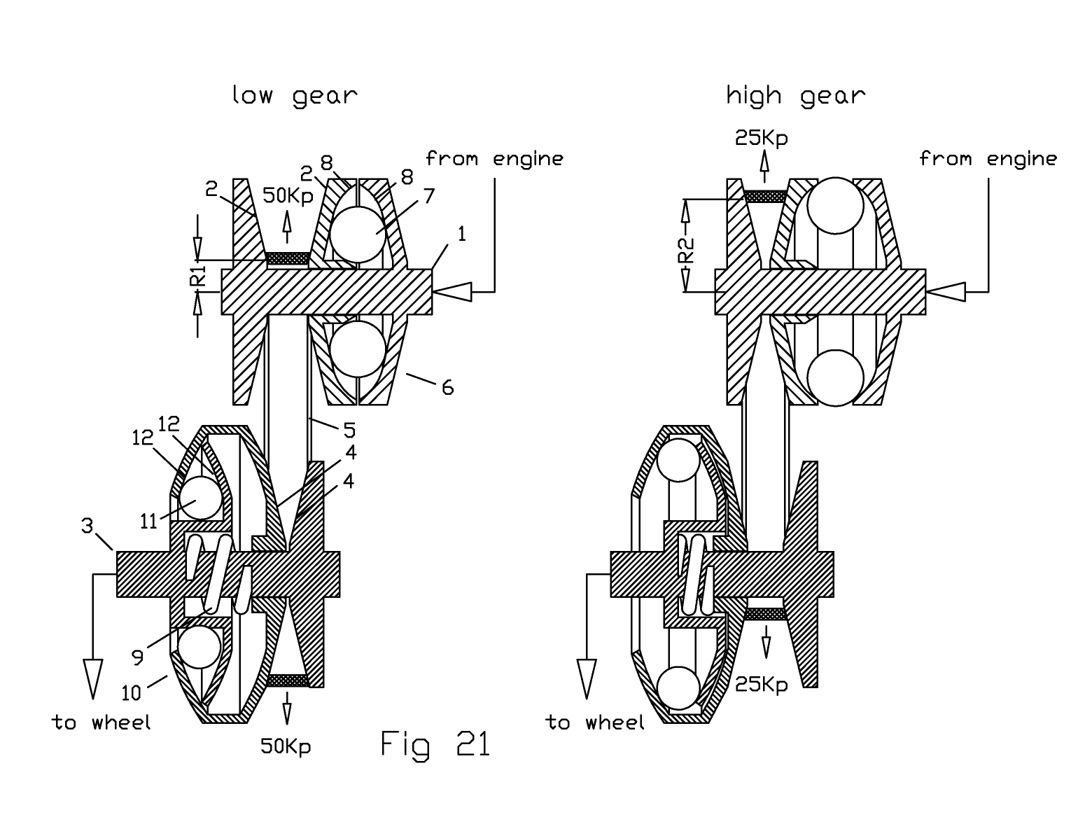

In a second preferred embodiment, FIGS. 19 to 21, the conventional V-belt CVT shown in FIG. 18 is modified by adding a centrifugal over-clamping compensation mechanism 10 that comprises weights (or rollers) 11 and properly shaped sliding surfaces 12 (others secured to the second shaft 3, others secured to the axially movable half of the second pulley 4).

As the revs of the second pulley increase (i.e. as the speed of the vehicle increases), the centrifugal forces acting on the weights 11 try to move them outwardly (i.e. at a bigger eccentricity) resulting in an axial force to the axially movable half of the second pulley. The direction of this force is opposite to the direction of the force the spring 9 applies onto the axially movable half of the second pulley. So, at higher angular speeds of the second pulley, the total axial force acting on the movable half of the second pulley reduces: the force from the spring increases because it is further compressed (case of higher gear ratio), but the opposite axial force from the centrifugal mechanism increases more.

With proper selection:

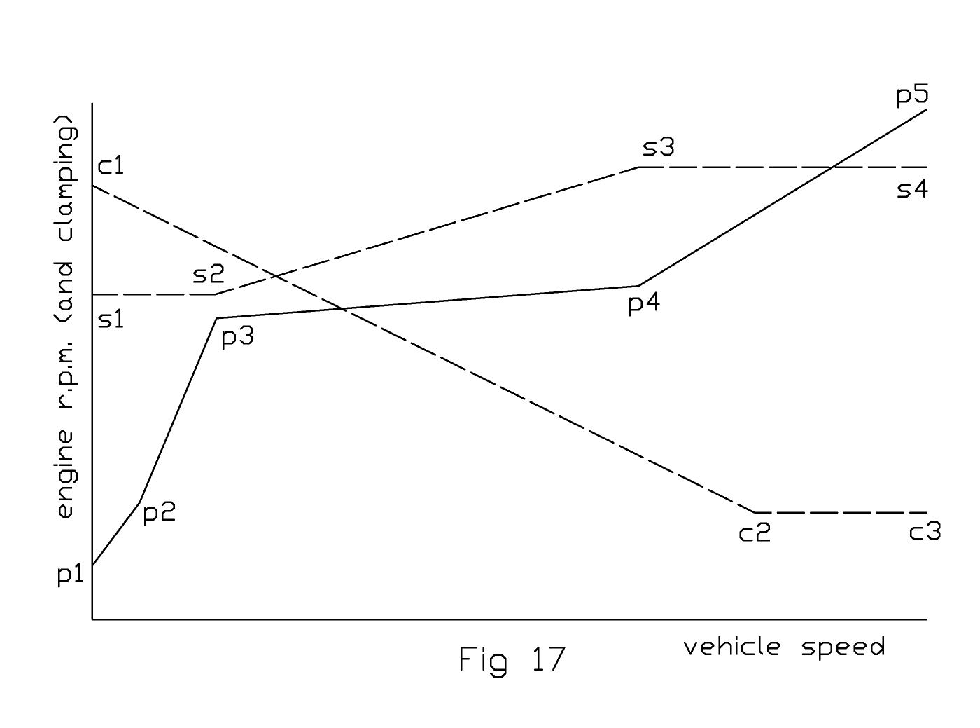

of the variator 6 (shape of sliding surfaces 8 and weight of the rollers 7),
of the centrifugal over-clamping compensation mechanism 10 (shape of the sliding surfaces 12 and of the weights 11), and of the spring 9,
the total axial force from the second pulley to the V-belt (i.e. the squeezing, the clamping) can drop substantially (as shown, for instance, by the c1-c2-c3 dashed line of FIG. 17), even when the force from the compressed spring increases.

A torque cam can be used in order to increase the clamping at heavier loads.

The second embodiment is applicable to every V-belt CVT, even to those not based on a centrifugal variator for the control of the transmission ratio (as happens, for instance, in the SECVT of Suzuki wherein the gear ratio is controlled electronically and not centrifugally).

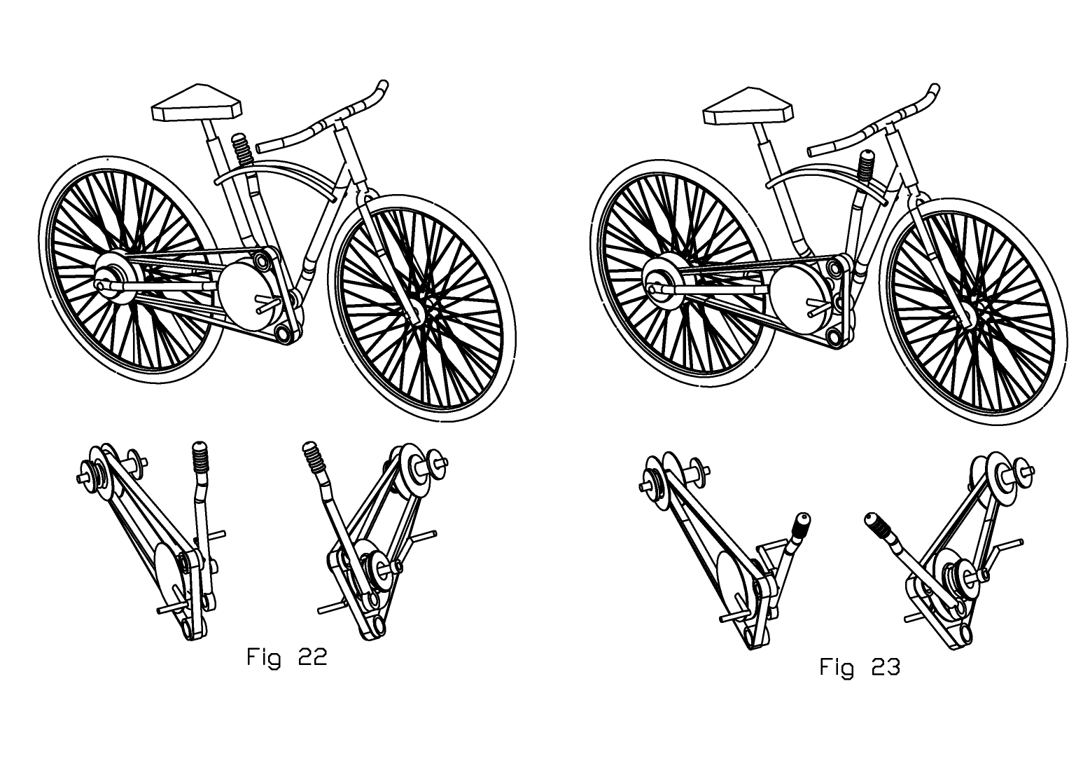

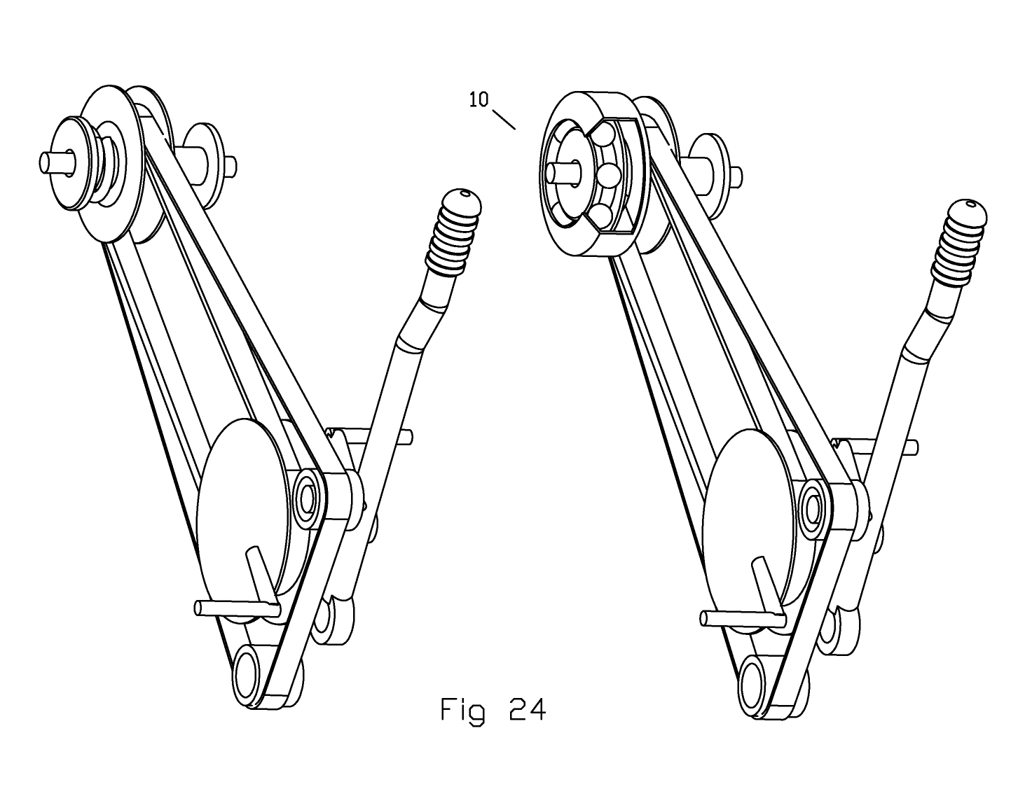

In a third preferred embodiment, FIG. 24, in the second pulley of the manually controlled CVT of FIGS. 22 and 23 it is added a centrifugal over-clamping compensation mechanism. At high speeds the strong centrifugal forces push the spheres/weights outwardly, which in turn apply to the movable half of the second pulley a force opposite to the force from the spring of the second pulley, which result in a reduction of the over-clamping of the V-belt.

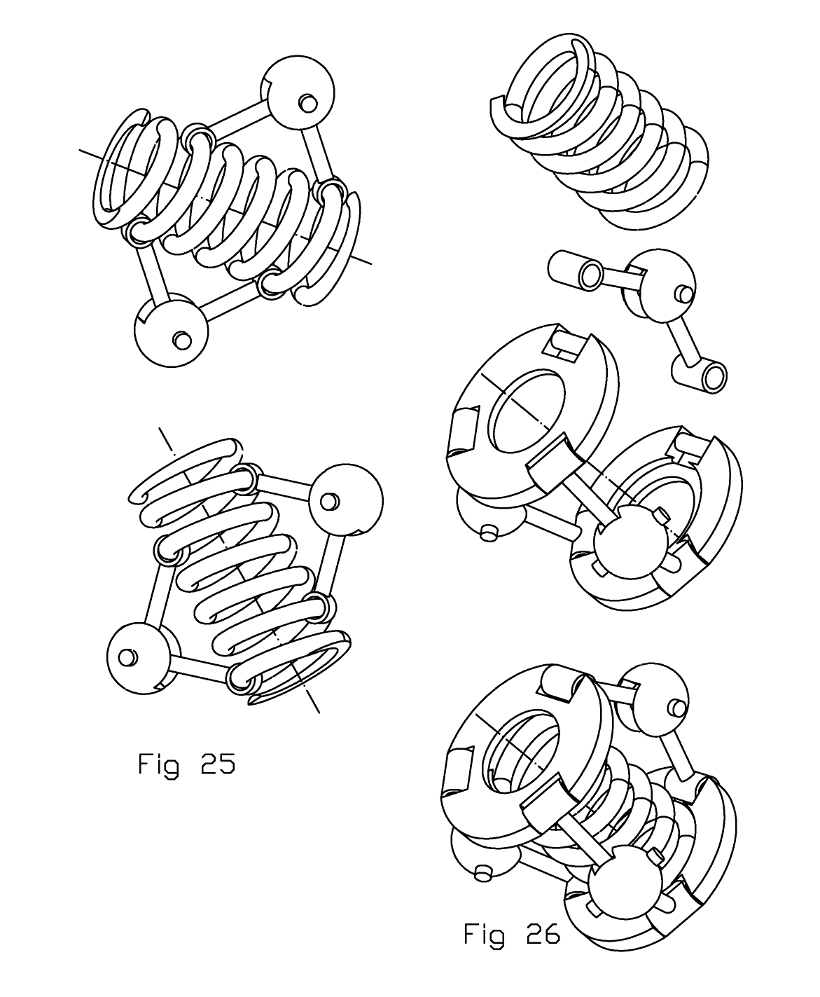

In a fourth preferred embodiment, FIG. 25, the over-clamping compensation mechanism is integrated with the spring of the second pulley. Weights properly linked on the spring, change the behavior of the spring: at high angular velocities the spring, with the weights on it, behaves as a much softer spring. By replacing the conventional spring of any V-Belt CVT of the art by a spring like that of FIG. 25, the over-clamping of the V-belt can substantially be reduced at the higher angular speeds of the second shaft. At low speeds of the vehicle (i.e. at low angular velocities of the second pulley) the spring behaves as a normal spring. In a different version of the fourth embodiment, FIG. 26, the spring is inside an articulated spring-cage having weights at an eccentricity. At higher angular speeds of the driven shaft the weights, through the spring-case, compress the spring and reduce substantially the over-clamping of the V-belt.

The previous are applicable not only on V-belt CVT's used in vehicles, but also in any V-belt Variable Transmission, for instance in V-belt Variable Transmission systems used in milling machines, in drills, in domestic appliances etc.

Although the invention has been described and illustrated in detail, the spirit and scope of the present invention are to be limited only by the terms of the appended claims.

1. A V-belt continuously variable transmission comprising at least:
a first shaft (1);
a first pulley (2) comprising two conical halves on the first shaft (1),
at least the one conical half of the first pulley (2) being axially movable with respect to the first shaft (1);
a second shaft (3);
a second pulley (4) comprising two conical halves on the second shaft (3), at least the one conical half of the second pulley (4) being axially movable with respect to the second shaft (3);
a spring (9), under the action of the spring (9) the two conical halves of the second pulley (4) move close to each other;
a V-belt (5), the V-belt (5) is engaging the first and second pulleys (2, 4) and is transmitting power between the first and second shafts (1, 3);
a controller (6), the controller (6) adjusting an effective diameter of one of the two pulleys (2, 4) varies a transmission ratio between the first and second shafts (1, 3), the second shaft (3) is rotating with an angular speed variable in a continuous range from lower angular speeds to higher angular speeds;
an over-clamping compensation mechanism (10),
at higher angular speeds of the second shaft (3) the over-clamping compensation mechanism (10) either reduces the action, or
counterbalances a part of the action, of the spring (9) on the second pulley (4), so that the V-belt over-clamping is substantially reduced improving the transmission efficiency and reliability.

2. A V-belt continuously variable transmission according claim 1, the spring (9) abutting at one end on a support (44) is acting, by its other end, on the second pulley (4),
depending on the power to be transmitted between the two shafts (1, 3) and depending on the angular speed of the second shaft (3),
the support (44) is properly displaced to substantially reduce the over-clamping of the V-belt (5).

3. A V-belt continuously variable transmission according claim 1, further comprising:
a support (44), the spring (9) abutting at one end on the support (44) is acting, by its other end, on the second pulley (4);
a control unit (41),
a servomotor (40), the servomotor (40) under the control of the control unit (41) displaces the support (44) increasing and decreasing as required the action of the spring (9) on the second pulley (4) in order to reduce or eliminate the over-clamping.

4. A V-belt continuously variable transmission according claim 1, further comprising:
a servo motor (40),
a control unit (41),
a support (44), the spring (9) abutting at one end on the support (44) is acting, by its other end, on the second pulley (4);
the control unit (41), based on the feedback from various sensors, checks for slipping of the V-belt and responds by commanding the servo motor (40) to displace properly the support (44) in order to reduce or minimize the over clamping of the V-belt.

5. A V-belt continuously variable transmission according claim 1, further comprising:
a servo motor (40),
a control unit (41),
a support (44), the spring (9) abutting at one end on the support (44) is acting, by its other end, on the second pulley (4);
the control unit (41) based on the feedback from various sensors,
a load sensor included, responds by commanding the servo motor (40) to displace properly the support (44),
the system is rid of a torque-cam mechanism.

6. A V-belt continuously variable transmission according claim 1, further comprising:
a support (44), the spring (9) abutting at one end on the support (44) is acting, by its other end, on the second pulley (4);
a servomotor (40) rotates a movable member that cooperates, through a thread, with a stationary member, the rotation of the movable member displaces the support (44) and varies a force the spring (9) applies to the second pulley (4).

7. A V-belt continuously variable transmission according claim 1, wherein:
a force the spring (9) is applying to the second pulley (4) can be substantially stronger when the two conical halves of the second pulley (4) are close to each other than when the two conical halves of the second pulley (4) are apart from each other.

8. A V-belt continuously variable transmission according claim 1, wherein:
the spring (9) is not following the rotation of the second pulley (4).

9. A V-belt continuously variable transmission according claim 1, wherein:
the spring (9) is rotating together with the second pulley (4).

10. A V-belt continuously variable transmission according claim 1, wherein:
a roller bearing is disposed between the spring (9) and the second pulley (4) so that the spring (9) is not following the rotation of the second pulley (4).

11. A V-belt continuously variable transmission according claim 1, wherein:
the transmission ratio is controlled by a centrifugal variator.

12. A V-belt continuously variable transmission according claim 1, wherein:
the over-clamping compensation mechanism (10) is a centrifugal mechanism on the second shaft (3), depending on the revs of the second shaft (3) the centrifugal mechanism (10) counterbalances a part of the force applied by the spring (9) to an axially movable conical half of the second pulley (4), so that at higher angular speeds of the second pulley (4) the over clamping of the V-belt (5) is substantially reduced.

13. A V-belt continuously variable transmission according claim 1, wherein:
the over-clamping compensation mechanism (10) is a centrifugal mechanism comprising weights (11) and sliding surfaces (12) wherein the weights (11) abut,
the weights (11) following the rotation of the second shaft (3) undergo centrifugal forces and, abutting on the sliding surfaces (12), are pushing an axially moving conical half of the second pulley (4) at a direction opposite to the direction the spring (9) pushes the same axially moving conical half of the second pulley (4).

14. A V-belt continuously variable transmission according claim 1, wherein:
the over-clamping compensation mechanism (10) is a centrifugal mechanism comprising weights (11) and sliding surfaces (12) wherein the weights (11) abut,
the weights (11) following the rotation of the second shaft (3) undergo centrifugal forces and, abutting on the sliding surfaces (12), push an axially moving conical half of the second pulley (4) at a direction opposite to the direction the spring (9) pushes the same axially moving conical half of the second pulley (4), with the push from the centrifugal mechanism (10) being more than half than the push from the spring (9) at higher angular speeds of the second pulley (4).

15. A V-belt continuously variable transmission according claim 1, wherein:
the controller (6) is a centrifugal variator comprising rollers (7) and sliding surfaces (8) wherein the rollers (7) abut,
the centrifugal forces acting on the rollers (7) displace an axially movable conical half of the first pulley so that the V-belt (5) runs on different effective diameters of the first pulley (2).

16. A V-belt continuously variable transmission according claim 1, wherein:
the controller (6) is a centrifugal variator comprising rollers (7) and sliding surfaces (8) wherein the rollers (7) abut,
the shape of the sliding surfaces (8) of the controller (6) is such that the resulting thrust force onto an axially moving half of the first pulley (2) reduces substantially at high gear ratios.

17. A V-belt continuously variable transmission according claim 1, wherein the over-clamping compensation mechanism (10) is a centrifugal mechanism comprising eccentric weights acting on the spring (9), the eccentric weights following the rotation of the second shaft (3) undergo centrifugal forces and act on the spring (9) by softening its action on the second pulley (4) at the higher angular speeds of the second shaft (3).
